(19) United States
(12) Patent Application Publication
(10) Pub. No.: US 2004/0088373 A1
(43) Pub. Date: May 6, 2004

(54) Method for information processing and information-processing client

(75) Inventors: Minna Karukka, Oulu (FI); Mika Mustonen, Ii (FI); Sami Ronkainen, Oulu (FI); Markku Rytivaara, Oulu (FI)

Correspondence Address: Crawford Maunu PLLC, Suite 390, 1270 Northland Drive, St. Paul, MN, 55120, US

(73) Assignee: Nokia Corporation

(21) Appl. No.: 10/658,924

(22) Filed: Sep. 10, 2003

(30) Foreign Application Priority Data
Sep. 11, 2002 (FI) 20021628

(51) Int. Cl. G06F 15/16

(52) U.S. Cl. 709/217; 709/245

(57) ABSTRACT

A method for information processing and an information-processing client are disclosed. The information-processing client is configured to access a server and to display first information returned by the server and containing a link to second information. The client is also configured to check automatically a specific property of the second information by making an enquiry concerning the second information and by displaying third information on the specific property of the second information.

### FIELD

The invention relates to a method for information processing and to an information-processing client.

### BACKGROUND

The amount of electronically available information is currently enormous. The information may reside in various data storages, for instance in databases or on information pages. The client/server architecture is often utilized in processing the information. A server usually contains a data storage, and the users of the system use their clients to access the information in the data storage of the server. Information processing is usually distributed between the client and the server.

When the client uses the server, first information is displayed, which contains a link to second information. The first information may be an information page, for instance, containing a link to a second information page. The first information can also be a search result obtained on a search page that then contains links to other information pages. The first information can also be a list of identification information of publications searched from a publication database, in which case the link then points to the publication in question.

When the information consists of web pages, “dead” links, i.e. links to information pages that do not exist or cannot at the time be browsed, constitute a problem. When the information consists of a list of publications obtained as a result of a search, the validity of the result in question constitutes a problem.

Various verification tools exist in the field, with which the administrator of a web site can examine the links included in the static information pages of the web site. The verification tools function on the server. A problem with the solution is that if the verification has not been done recently, the link may already be dead, even though it was not in the previous verification. The solution also does not work with dynamically generated information pages, for instance when the server is a search engine, except when the verification is performed on all links in the search engine. In practice, this would, however, be a huge operation due to the enormous size of the database. Another problem is that the verification should be performed sufficiently often so as to make its result reliable. In addition, the usability of the links depends on the location of the client in relation to the server containing the second information and on the quality of the used telecommunications connection; the server containing the first information cannot, in practice, easily find out this information or maintain it.

### BRIEF DESCRIPTION

The invention seeks to provide an improved method for information processing and an improved device.

As an aspect of the invention, a method for information processing is disclosed, the method comprising: accessing a server with a client, displaying in the client first information returned by the server and containing a link to second information, checking automatically a specific property of the second information by making an enquiry concerning it, and displaying in the client third information on the specific property of the second information.

As a second aspect of the invention, an improved information-processing client is disclosed, the client being configured for: accessing a server, displaying first information returned by the server and containing a link to second information, checking automatically a specific property of the second information by making an enquiry concerning it, and displaying third information on the specific property of the second information.

The invention is based on checking automatically a specific property of the second information, for instance the usability of a second information page, by making an enquiry concerning the second information, for instance by making an enquiry to the second information page. The novelty with static information pages is that the enquiry is made by the client and with dynamic information pages that the enquiry is made at all. Third information is then displayed on the checked specific property to indicate clearly to the user what is the usability of the second information page, for instance.

The method and device of the invention provide several advantages. The user of the client receives up-to-date information on the properties of the second information, such as the usability of the second information pages. With the invention, it is also possible to efficiently perform the usability check of dynamic information pages, which is impossible with the prior art, since search engines can provide hundreds or thousands of millions of different links as search results.

### LIST OF FIGURES

The invention will now be described in greater detail by means of the preferred embodiments and with reference to the attached drawings, in which

FIG. 1 illustrates the client/server architecture,

FIG. 2 is a flow chart illustrating a method for information processing,

FIG. 3 is a flow chart illustrating a method for information processing in a browser,

FIG. 4 is a flow chart illustrating a method for information processing in a browser using a search page, and

FIG. 5 is a signal diagram illustrating an example of information processing in the client/server architecture.

### DESCRIPTION OF THE EMBODIMENTS

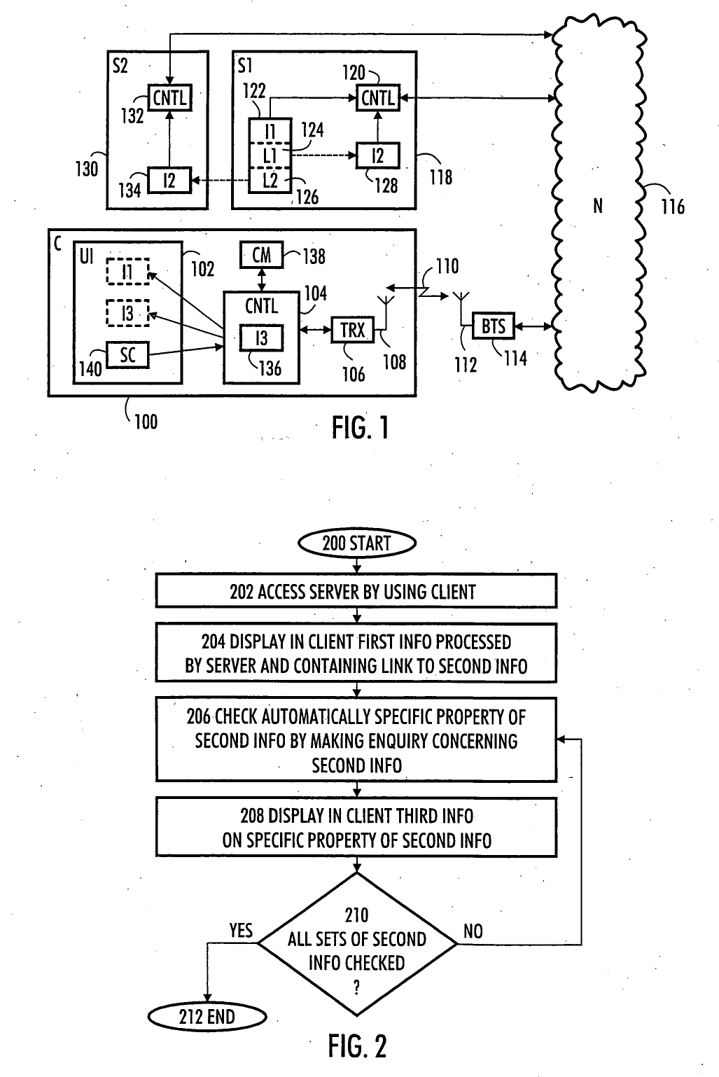

The structure and operation of the client/server architecture are described in a suitably simplified manner with reference to FIG. 1. In the example, the client 100 processing information comprises a browser that is used to display information pages in the user's device. The information pages can be web pages or WAP (wireless application protocol) pages, for instance. HTML (hypertext markup language), XHTML (extensible hypertext markup language) or WML (wireless markup language), for instance, can be used to describe the information pages.

In our example, the client 100 is a radio system subscriber terminal, but it is clear that it can also be a normal personal computer, portable computer, PDA (personal digital assistant) device or some other information processing device, in which the client of the client/server architecture can be implemented. Several different technologies can be combined in the client, i.e. it can for instance be a combination of a subscriber terminal and PDA device, of which the Nokia® Communicator™ is one example.

In our example, the client 100 is a radio system subscriber terminal and comprises an antenna 108 and a radio transceiver 106. The radio transceiver 106 is a prior-art mobile phone transceiver, for instance, operating in the GSM (global system for mobile communications) system, GPRS (general packet radio service) system, and/or UMTS (universal mobile telecommunications system) system. A radio link 110 can then be established from the client 100 to the network part of the radio system, which in our example is a base station 114 with its antennas 112.

A wireless local area network can also be used to establish the radio link 110. In a wireless local area network, a physical cable is replaced by a radio link, microwave link or infrared link. The wireless local area network can be for instance a wireless local area network according to the IEEE (The Institute of Electrical and Electronics Engineers, Inc.) standard 802.11 or 802.11b. The radio transceiver 106 can be implemented using the Bluetooth™ technology, for instance, in such a manner that an integrated circuit using Bluetooth™ is placed in both the client 100 and the network part 114, whereby a radio link 110 covering at most a few hundred metres on the 2.4-gigahertz frequency is provided.

The subscriber terminal 100 also comprises a processing unit 104 that controls and monitors the operation of the device and its parts. In addition, the processing unit 104 contains the application software of the device for radio signal processing, information processing and user interface management, for instance. In our example, the processing unit 104 also contains a browser. Today, the processing unit 104 is usually implemented as a processor including software, but various hardware solutions are also possible, for instance a circuit built of separate logic components or one or more application-specific integrated circuits. If necessary, there may also be more than one processor. A combination of these different implementation methods is also possible. When selecting the implementation method, a person skilled in the art will take into consideration for instance the requirements set for the size and power consumption of the device, the necessary processing power, manufacturing costs and production quantities. The configuration of the processing unit 104 forms structural entities that can be implemented for instance as program modules, that is, in some programming language, such as C, C++, machine language or Assembler, which is stored as a runnable version in a memory in the processing unit 104 and which is run with the processing unit 104. Instead of compilation programming languages or in addition to them, it is naturally also possible to use interpretive programming languages, if their use enables the required processing rate and power. When the processing unit 104 is implemented as ASIC, the structural entities are ASIC blocks.

In addition, the subscriber terminal 100 comprises a user interface 102 connected to the processing unit 104. The user interface 102 can be implemented according to the prior art. The user interface 102 may comprise a keyboard for controlling the subscriber terminal, entering information and giving information processing commands, a display for displaying information, and a microphone and loudspeaker for sound processing. A chargeable battery is usually the power source. The terminal also comprises a memory connected to the processing unit 104 for storing information. The memory can be implemented using the prior art ways to realize non-volatile memory, for instance as memory circuits or a small hard disk.

FIG. 1 does not describe the structure of the network part of the radio system in greater detail, because the structure is clear to a person skilled in the art on the basis of professional books and standards, such as Juha Korhonen: Introduction to 3G Mobile Communications, Artech House 2001, ISBN 1-58053-287-X. A connection can be established from the base station 114 providing the radio link 110 to a data transmission network, such as the worldwide open Internet 116 or to some other data transmission network implemented by known technology, such as a closed intranet of an organization. A connection can be established between the client 100 and server 118, 130 through the data transmission network 116. In our example, there are only two servers 118, 130, because they are sufficient to describe information processing at a sufficient accuracy, but in reality, there may be numerous servers; in the Internet, for instance, there are tens of millions.

Up till now, the structure of the client/server architecture has been described in a static state. So as to illustrate information processing, we will, in the following, present a dynamic description from the viewpoint of the client 100.

The client 100 is configured to contact the server 118. The connection can be established as shown in FIG. 1, for instance, in which the client 100 has a radio link 110 to the base station 114. A connection is established from the base station 114 over the data transmission network 116 to the server 118. The radio link 110 can use circuit-switched or packet-switched transmission. TCP/IP (transmission control protocol/Internet protocol), for instance, can be used to establish the connection in the data transmission network 116. The server 118 can be a server computer, for instance, in which the necessary software is run in a processing unit 120. In our example, the server 118 makes information pages available to the client 100. For the sake of clarity, FIG. 1 only shows one information page 122, but in practice, there are a multitude of them. The first information page 124 contains a link to a second information page. Our example shows two of these links: the first link 124 is a link to a second information page 128 on the same server 118, and the second link 126 is a link to a second information page 134 on a second server 130. The link 124, 126 can for instance be a hypertext link that is distinguished from the rest of the first information 122 by colour or underline, for instance.

The client 100 is configured to display the first information 122 returned by the server 118 and containing a link 124, 126 to the second information 128, 134. The client 100, a browser in our example, thus accesses the server 118 and downloads the first information page 118 from it to be displayed on the user interface 102, a display belonging to the user interface 102 in our example.

The client 100 is also configured to automatically check a specific property of the second information 128, 134 by making an enquiry concerning the second information 128, 134, and to display third information 136 on the specific property of the second information 128, 134. In our example, this specific property of the second information 128, 134 is usability. The processing unit 104 can be configured to display the first information 122, to process the second information 128, 134 and to display the third information 136 in parallel or alternatingly.

When processing information pages in the usual manner, one entire page is fetched to the client 100; for instance when using HTTP (hypertext transfer protocol), this is done with the GET method. If there are several links 124, 126, it may be preferable to configure the client 100 to fetch the header of the second information page 128, 134. The header only provides information on the page and its status. When using HTTP, the client 100 can be configured to make the enquiry by the HEAD method that browsers usually use to examine if an information page corresponding to a bookmark has been updated. The bookmark can define an URL (uniform resource locator) that is stored in the list of favourites of the browser. Additional information on HTTP can be obtained from the document “Hypertext Transfer Protocol—HTTP/1.1” drafted by the ISOC (Internet Society) Network Working Group and dated June 1999 that is available on the IETF (Internet Engineering Task Force) web pages at http://www.ietf.org. A typical web page returns approximately 300 bytes with the HEAD method, in which case the checking of the usability of the second information pages 128, 134 pointed to by one hundred links only generates approximately 30 Kbytes of traffic towards the client 100.

The fetched and/or generated third information 136 can for instance be the following: the downloadability of the second information 128, 134 onto the client 100, the downloading rate of the second information 128, 134 onto the client 100, the downloading time of the second information 128, 134 onto the client 100, the download size of the second information 128, 134 onto the client 100, the bandwidth of the data transmission path used for downloading the second information 128, 134 onto the client 100. For instance, when using HTTP, the status field can be “200”, which means that the page is OK and thus downloadable, or “400”, which means that the page cannot be found and is thus not downloadable. When using HTTP, the download size is obtained from the content length field that indicates the actual content length of the information page as a number of octets. When the HEAD request is transmitted, a timer can be started that is then stopped when the reply arrives: the downloading rate of the entire information page can then be estimated on the basis of the timer, the header field size and the content length field. The downloading time can be estimated on the basis of the download size and the downloading rate.

The client 100 is configured to display the third information 136 visually in connection with the link. The client 100 can be configured to provide the visuality in the first information 122 displayed in the client 100 for instance as follows: by colouring the link 124, 126 in a manner agreed in advance, by altering the font of the link 124, 126 in a manner agreed in advance, by placing an icon beside the link 124, 126, by changing the order of the links 124, 126, by displaying the third information 136 in a window opened beside the link 124, 126. The link 124, 126 can be coloured in such a manner, for instance, that if the links are normally displayed in blue on the display of the user interface 102 of the client 100, non-functioning links can be displayed in red. Altering the font of the link 124, 126 means that if the links are normally displayed in a normal font, non-functioning links can be displayed in some other font, such as struck through. The icon placed beside a non-functioning link can for instance be a universal symbol depicting the fact that something does not exist any longer, for instance a skull to indicate that the link is “dead”. The order between the links 124, 126 can also be changed for instance by arranging the links in the order of superiority in terms of usability. Unchecked links 124, 126 can be displayed as usual or they, too, can be indicated visually. A window opened in connection with the link can be implemented in such a manner, for instance, that when the user points to the first link 124 displayed in the user interface 102, a pop-up window opens displaying the third information 136 as long as the cursor is at the link 124 in question. When the user then points to another link 126, another pop-up window opens. This embodiment makes it possible to show the third information 136 of only the links that the user wants.

In practice, the download size of the second information 128, 134 onto the client 100 usually means the size of the file to be downloaded. The client 100 can be configured to display the size of the file visually in such a manner that the item displaying the file in the first information 122, for instance the link 124, 126, is coloured according to the size of the file. Table 1 shows an example of how the size of files of different types can be displayed by colour: the first column shows the colour and the second column the file size corresponding to the colour.

TABLE 1

| | |
|---|---|
| Colour | Size of file |
| Red | ≧1 megabyte |
| Violet | ≧500 kilobytes and <1 megabyte |
| Green | ≧100 kilobytes and <500 kilobytes |
| Blue | <100 kilobytes |

The bandwidth of the data transmission path used to download the second information 128, 134 onto the client 100 is usually determined in such a manner that the part of the data transmission path using the narrowest bandwidth determines the bandwidth of the entire path. For instance in FIG. 1, when downloading the second information 134, the data transmission path is made up of the connection between the second server 130 and the data transmission network 116, the connection established in the data transmission network 116, the connection between the data transmission network 116 and the network part 114 of the radio system, the connection established in the network part 114 of the radio system, and the radio link 110 between the network part 114 of the radio system and the client 100. The client 100 can be configured to display the bandwidth of the data transmission path visually in such a manner that the symbol depicting the bandwidth in the user interface 102 is coloured according to the bandwidth. Table 2 shows an example of how bandwidths of different sizes can be displayed: the first column shows the colour, the second column shows the bandwidth corresponding to the colour and the third column shows an example of what type of radio link 110 is used, since the bandwidth of the radio link 110 is usually the narrowest in the entire data transmission path and, thus, a limiting factor. WCDMA (wide-band code division multiple access) is a technology used in UMTS for implementing the radio link.

TABLE 2

| Colour | Bandwidth | Radio link type |
|---|---|---|
| Black | No network connection | — |
| Green | 9.6 kilobits per second | GSM |
| Blue | 126 kilobits per second | GPRS |
| Red | 360 kilobits per second | WCDMA |

The size of the file and the bandwidth can thus be displayed visually as shown in the examples. The display methods can also be applied in such a manner that already when the web page is being built, the links can be coloured to indicate the size of the link. It is also possible to apply colour to the web page when it is being built to indicate what kind of bandwidth is required to download a certain link. A coloured symbol can also be used in the user interface 102 to indicate the currently used bandwidth. The user can thus see from the colours of the user interface 102 both the currently used bandwidth and the bandwidth needed to download a certain file. This way, the user can quickly determine whether a certain link is worth clicking. For instance, if the currently used bandwidth is illustrated by green, the user will quickly understand that if s/he clicks a red link, downloading will fail or take a long time.

Browsers typically have an address bar that shows the link being browsed. In addition, browsers typically have a downloading indicator in a separate field that shows in real-time how much of the file being downloaded has already been downloaded. The address bar and downloading indicator can be combined in such a manner that the combined bar shows the link being downloaded normally with alphanumeric characters (for instance http://www.nokia.com) and behind the text for example a coloured rectangle is shown that grows from left to right. In the combined bar, a certain space is reserved for the rectangle. The area of the rectangle in relation to the space reserved for it indicates how much of the file is downloaded. For instance, if a space of ten centimetres in width (the height can be half a centimetre, for instance) is reserved for the rectangle, the rectangle does not show at all on the combined bar in the beginning, because the downloading of the file has not yet started. In the beginning, the combined bar thus only shows the link. As the downloading progresses, a coloured rectangle starts to grow behind the link from left to right. For instance, after half of the file is downloaded, the rectangle covers five centimetres of the space reserved for it. When the downloading is completed, the rectangle covers the entire ten centimetres reserved for it.

Additional information, such as the size of the file and/or bandwidth, can also be added to the combined bar. The additional information can be displayed by colouring the rectangle with a certain colour. For instance, if the size of the file to be downloaded is more than one megabyte, the rectangle is coloured red. The area of the rectangle then quickly shows how much of the file is downloaded and the colour of the rectangle shows the size of the file being downloaded.

The rectangle can also be divided horizontally in more than one part. Then each part displays a certain type of additional information. The upper part of the rectangle can in the manner described above display the size of the file being downloaded and the lower part can display the bandwidth. If the used bandwidth is 126 kilobits per second, for instance, then the lower part of the rectangle is coloured blue. In our example, the rectangle grows from left to right, the address of the browsed link is shown in front of the rectangle, the upper part of the rectangle is coloured red and the lower part blue. The combined bar is updated in real-time or at regular intervals. For instance, if the used bandwidth changes during downloading, for instance decreases to 9.6 kilobits per second, this can be indicated to the user by changing the colour of the lower part of the rectangle; in our example, this colour is green. The user can then interrupt the downloading, if the used bandwidth decreases too much.

The described combined bar can in a small space efficiently display different kinds of information concerning the browsed object and the progress of the browsing. Instead of the combined bar, a downloading indicator according to the prior art can also be changed to use the above-mentioned divided rectangle. It is clear that the downloading indicator need not be in the shape of a rectangle, but geometric shapes of other kind can also be used on the condition that the user can easily discern the total amount of downloading and how much has already been downloaded as well as possibly displayed additional information.

In one embodiment, the client 100 is configured to download the second information 128, 134 to a cache memory 138 of the client 100, if the third information 136 indicates that the second information 128, 134 is downloadable. The cache memory 138 is a buffer arranged to the processing unit 104, to which information can be downloaded to speed up access to it. According to this embodiment, the second information 128, 134 can be downloaded already in advance to the cache memory 138, if the second information 128, 134 has been found downloadable. If the user of the client 100 then clicks on a link 124, 126 that points to a second information page 128, 134 already downloaded to the cache memory 138, the information page 128, 134 in question can immediately be displayed on the user interface 102 of the client 100, for instance on a display belonging to the user interface 102. Links 124, 126 pointing to the second information pages 128, 134 already downloaded to the cache memory 138 can also be indicated visually.

In one embodiment, the client 100 is configured to download only the text content of the second information 128, 134. When using HTTP, the first GET request does not download anything else than the HTML page that is only text. The images possibly on the page should then be downloaded separately one at a time. This embodiment helps avoid the amount of data downloaded to the cache memory 138 from growing too large.

In one embodiment, the client 100 is configured not to perform any automatic functions included in the second information 128, 134 during download to the cache memory 138. The automatic functions can for instance be pop-up windows written with JavaScript on the information page 128, 134. This embodiment helps avoid that the user interface 102 of the client 100 shows information that the user of the client 100 has not selected yet.

In one embodiment, the client 100 is configured to perform a download to the cache memory 138, if the size of the second information 128, 134 is at most equal to a preset limit. The size of the second information 128, 134 is obtained for instance from the reply message of the HEAD method described above. This embodiment makes it possible to control the use of the cache memory 138 so that too large amounts of data are not downloaded into the cache memory 138, which might for instance cause too high costs from the use of the radio link 110.

In one embodiment, the client 100 is configured to perform a download to the cache memory 138, if the second information 128 is on the same server 118 as the first information 122. This embodiment endeavours to provide a sensible downloading to the cache memory 138, as it is often so that the interest of the user is directed to a certain WWW (worldwide web) server, in which case it is more probable that the user clicks on a link 124 that points to a second information page 128 on the same server 118 than on a link 126 that points to a second information page 134 on another server 130.

In one embodiment, the client 100 is configured to start checking the second information 128, 134 from the first displayed link 124. This embodiment takes into account the fact that a user of the client 100 usually reads the first information 122 through sequentially when the first information 122 is displayed on the user interface 102 of the client 100. It is then more probable that the second information 128, 134 is already checked by the time the user wants to click the link 124, 126 pointing to the second information 128, 134.

In one embodiment, the client 100 is configured to perform the checking of the second information 128, 134 for the links 124, 126 displayed at each time, if there are more links 124, 126 than the client 100, or the display of its user interface 102, can display at one time. Especially if the client 100 is a subscriber terminal of a radio system, the display can be very small and thus cannot display all the links 124, 126 at one time. This embodiment, too, aims at checking the second information 128, 134 in an order that would be as beneficial as possible for the user of the client 100.

In one embodiment, the server 118 contains a search page. The server 118 can then be a search engine. A search engine is a program that searches for information from the Internet, intranet or extranet, for instance, lists information and searches for information on the basis of a search request. There are different kinds of search engine: the search may cover the title, URL, header, or entire text of a document. The search engine may be dedicated to one web site. The search engine may also try to cover a certain part of the Internet; examples of such a search engine are AltaVista™ and Google™. To process search pages, the client 100 is configured to display the search page of the server 118 on the display of the user interface 102, for instance; to receive the search criterion 140 entered for instance by entering search words into a field on the search page by means of the keyboard belonging to the user interface 102 of the client 100; to start the search on the search page on the basis of the search criterion 140; and to obtain the first information 122 to be displayed as a result of the conducted search. It has been assumed in the examples so far that the first information 122 already exists, and is an existing information page on a web site, for example. In this embodiment, the first information 122 is thus generated on the basis of the user's search, i.e. the first information is a list obtained as a result of the search and containing links 124, 126 to second information pages 128, 134.

In one embodiment, the server 118 contains a data storage (not shown in FIG. 1) from which the client 100 can retrieve information. The client 100 is then configured to receive a search criterion 140, to start a search through the first data storage on the basis of the given search criterion 140, to obtain the first information 118 to be displayed as a result of the conducted search, and to conduct a search concerning the second information 128, 134 by analysing the first information 118 and conducting a search to a second data storage (not shown in FIG. 1). The second data storage may be on the same server 118 as the first one, or on another server 130. As an example, let us describe a situation, in which the first data storage is a publication database and the second data storage is a reference database. The first information 118 then comprises information concerning publications and the third information 136 comprises information on the relevance of the publication to the search criterion 140. The user of the client 100 then enters the search term or terms and presses the “Search” button. First, the first information 122 is displayed, i.e. all the titles of the publications found with the terms entered by the user in one list. Then the server 118 or client 100 starts to view the second information 128, 134, i.e. the links 124, 126 are now references to found publications. In our example, the viewing is done by searching more publications independently from the reference database (in the Internet, for instance) and checking for instance whether nearly all of them have a reference to one specific publication. Let us further assume that this publication is also included in the results of the conducted search, but not very high on the list (for instance because the publication only contains two of the three used search terms). Now, it is presumable that the publication is, however, significant, so the third information 136, i.e. the relevance of the publication to the search, can be visually emphasized as described above, for instance the publication can be put higher on the publications list or otherwise emphasized by changing the colour of the publication on the list. The first information 122 can thus be a different kind of dynamic “on-demand” content that is not generated until used, or at least the user sees it for the first time when it is being used, and that is first displayed as a kind of draft version and is then automatically processed further as described above.

Next, a method for information processing is described with reference to the flow chart of FIG. 2. The execution of the method is started from 200. Next in 202, the client accesses the server and in 204, the client displays the first information returned by the server and containing a link to second information. After 204, or partially parallel to it, in 206, a specific property of the second information is checked automatically by making an enquiry concerning the second information. Finally, after 204, or partially parallel to it, in 208, third information concerning the specific property of the second information is displayed in the client. There may be more than one set of the second information, in some cases a plurality of them, such as tens or hundreds or even thousands, which means that steps 206 and 208 are repeated for each set of second information. The repetition is done for instance by checking in 210 whether all the sets of second information have been checked: if yes, then the operation moves to 212, in which the execution of the method is terminated, otherwise the operation moves from 210 to 206 as indicated by the arrow.

The server or the client can make the automatic check. An embodiment, in which the client makes the automatic check, has the advantage that the information processing capacity of the server is not loaded. On the other hand, telecommunications connections possibly required to check the second information are then billed to the client.

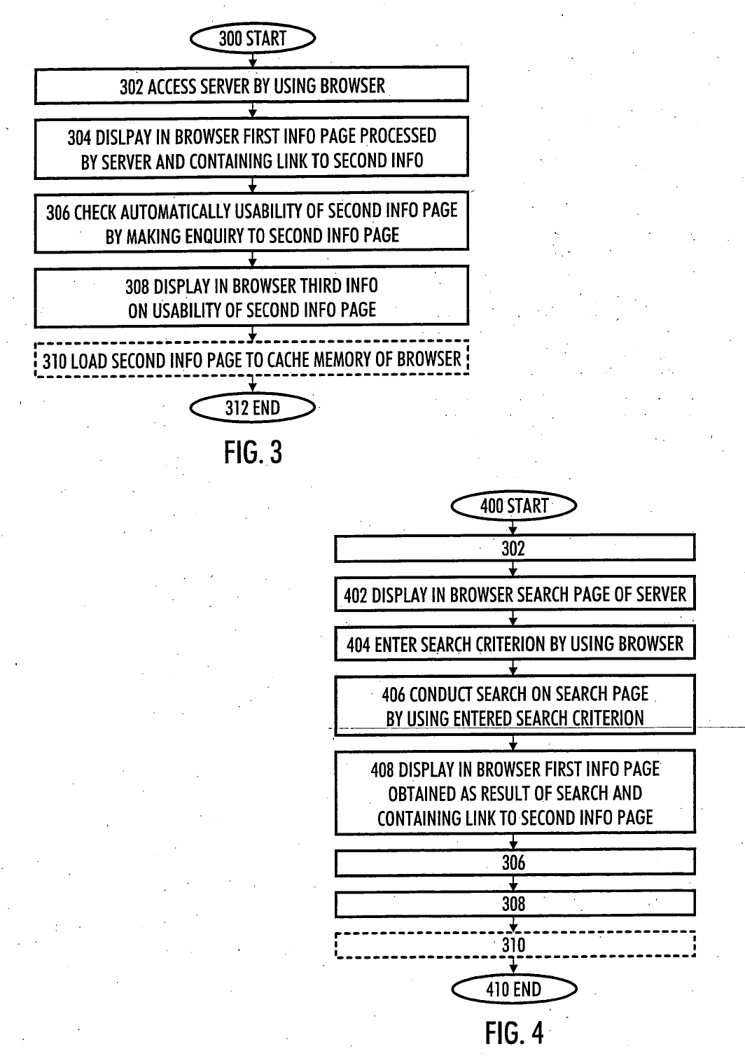

In one embodiment, the client comprises a browser, the first information is a first information page, the second information is a second information page and the specific property is usability. This embodiment is illustrated next in FIG. 3, which is used to describe a method for information processing in a browser. A browser used to display information pages in the device of the user is now the client. The performance of the method is started in 300. Next, in 302, the client accesses the server. Then, in 304, a first information page returned by the server and containing a link to a second information page is displayed in the browser. After 304 or partly parallel to it, 306 is executed, in which the usability of the second information page is checked automatically by making an enquiry to the second information page. In one embodiment, in the enquiry of 306, only the header of the second information is fetched and not the entire second information page, whereby the possibly needed telecommunications capacity remains considerably lower than otherwise. This enquiry of 306 can be made using the HTPP HEAD method as described above.

Because the user usually browses the user interface of the client, i.e. in our example the browser, in an organized manner, the checking of the second information performed in 306 can be started from the first displayed link. In addition, if there are more links than the client can display at one time, the checking of the second information can be done in 306 on the links displayed at each time. That is, if the display of the client's user interface cannot show all the first information in one go, then first the sets of second information are checked that are on the display and then the sets that do not fit on the display. If a large amount of information does not fit on the display, the part of the information is naturally checked first that is displayed next when the user scrolls downwards.

After 306 or partly parallel to it, in 308 the browser displays third information on the usability of the second information. The third information can be the following, for instance: the downloadability of the second information onto the client, the downloading rate of the second information onto the client, the downloading time of the second information onto the client, the download size of the second information onto the client, the bandwidth of the data transmission path to be used to download the second information onto the client. The execution of the method is ended in 312. Optionally, in the method, the second information can, as shown in 310, be downloaded to the cache memory of the client, if the third information indicates that the second information is downloadable. The download to the cache memory can be done after all other information has been processed, or it can be done at the same time in such a manner that after the usability of a set of second information has been checked, the second information is possibly downloaded to the cache memory. In the method of FIG. 3, it is thus possible to use the iteration loop shown in 210 of FIG. 2 to process the second information. In both methods, the processing can also be done in such a manner that in 206/306, first all sets of the second information are checked and then in 208/308, all generated sets of the third information are displayed.

In one embodiment, in 310, only the text content of the second information is downloaded so that memory processing and/or telecommunications capacity use did not become a problem. To avoid the same problem, download to the cache memory can be done only if the second information is at most equal in size to a preset limit. In addition, download to the cache memory can be done only if the second information is on the same server as the first information.

In one embodiment, in 310, automatic functions included in the second information are not executed during download to the cache memory. This prevents the client's user interface from displaying anything related to the sets of second information that the user has not yet selected.

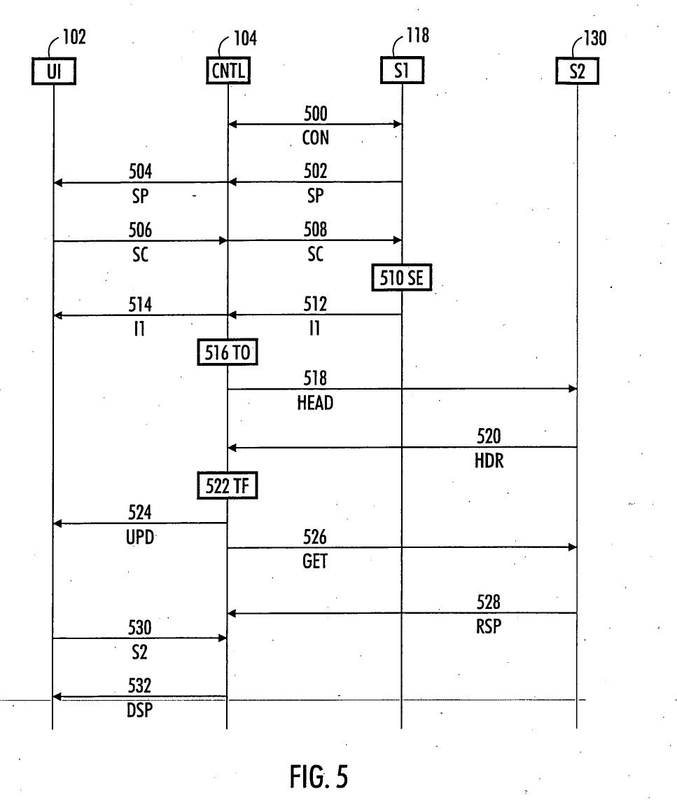

In one embodiment, the server contains a search page that the browser accesses. This embodiment generates the method for information processing in the browser using the search page, and it is described next with reference to FIG. 4. In addition, reference is made to FIG. 5 that is a signal diagram illustrating information processing in the client/server architecture.

The execution of the method is started in 400. Then, as in 302, the browser accesses the server, i.e. according to 500, a connection is established between the processing unit 104 of the client and the first server 118. Next, in 402, the search page of the server is displayed in the client, i.e. according to 502, the search page is moved from the first server 118 to the processing unit 104 and then, according to 504, on to be displayed on the client's user interface.

Next, in 404, a search criterion is entered in the client, i.e. according to steps 506 and 508, the search criterion is moved from the user interface 102 through the processing unit 104 to the first server 118. When the search criterion is received, in 406, a search is conducted on the search page on the basis of the search criterion, i.e. according to 510, in the first server 118. In the method of FIG. 4, the first information displayed in the client is obtained as a result of a conducted search and in 408, the browser displays the first information page obtained as a result of the search and containing a link to the second information page. The first information page is thus, according to steps 512 and 514, moved from the first server 118 to the processing unit 104 and on to the user interface 102.

It is then possible, according to 306, to check automatically the usability of the second information page by making an enquiry to the second information page and, according to 308, to display in the browser the third information on the usability of the second information page. In our example of FIG. 5, the second information page resides on a different server than the first information page, i.e. search page. Then according to 518, the processing unit 104 sends an enquiry according to the HEAD method to the second server 130 and receives, according to 520, a header as the reply. The third information is then displayed according to 524 by the processing unit 104 and the user interface 102 in cooperation. The execution of the method described in FIG. 4 is ended in 410.

The embodiments defined for the method described in FIG. 3 also work for the embodiment described in FIG. 4; for instance the download of the second information pages to the cache memory according to 310 that is done in FIG. 5 by sending a GET method request according to 526 from the processing unit to the second server 130 and receiving the second information page as the reply according to 528. When the user interface 102 then sends the command 530 to retrieve the second information page, it can according to 532 be directly transmitted from the cache memory of the processing unit 104 to be displayed on the user interface 102. In addition, FIG. 5 shows how it is possible to determine the downloading rate: before sending the enquiry, a timer is started according to 516 and the timer is then stopped according to 522 after the reply is received. The downloading rate can then be estimated by the time elapsed in the timer and the amount of data downloaded during this time. The downloading time for the second information page is then obtained on the basis of the estimated downloading rate and the download size of the second information page.

In one embodiment, the method also comprises: providing a search criterion with the client, conducting a search to the first data storage on the basis of the search criterion, obtaining the first information to be displayed in the client as a result of the conducted search, and making an enquiry concerning the second information by analysing the first information and making an enquiry to the second data storage. This embodiment is thus not limited to the embodiments described earlier, in which the client is a browser. In one embodiment, the first data storage is a publication database and the second data storage is a reference database. In one embodiment, the first information comprises information on publications and the third information comprises information on the relevance of the publication to the search criterion.

In the method, the third information can be displayed visually with the link. This visuality can be implemented in the following manner, for instance: colouring the link in an agreed manner, changing the font of the link in an agreed manner, placing an icon agreed in advance beside the link, changing the order of the links, displaying the third information in a window opened in connection with the link.

The method can be carried out using a client described above in FIG. 1, but it is clear that suitable client/server architecture solutions of other types can also be applied.

Even though the invention is above described with reference to an example according to the attached drawings, it is clear that the invention is not limited to it, but can be modified in many ways within the scope of the inventive idea disclosed in the attached claims.

1. A method for information processing, comprising:
accessing a server with a client,
displaying in the client first information returned by the server and containing a link to second information,
checking automatically a specific property of the second information by making an enquiry concerning it, and
displaying in the client third information on the specific property of the second information.

2. A method as claimed in claim 1, wherein the client comprises a browser, the first information comprises a first information page, the second information comprises a second information page, and the specific property comprises usability.

3. A method as claimed in claim 2, wherein the third information comprises at least one of the following: the downloadability of the second information onto the client, the downloading rate of the second information onto the client, the downloading time of the second information onto the client, the download size of the second information onto the client, the bandwidth of the data transmission path used for downloading the second information onto the client.

4. A method as claimed in claim 2, further comprising: loading the second information to a cache memory of the client, if the third information indicates that the second information is downloadable.

5. A method as claimed in claim 4, comprising: loading only the text content of the second information.

6. A method as claimed in claim 4, comprising: not executing any automatic functions included in the second information in connection with the download to the cache memory.

7. A method as claimed in claim 4, comprising: performing the download to the cache memory if the second information is at most equal in size to a preset limit.

8. A method as claimed in claim 4, comprising: performing the download to the cache memory if the second information resides on the same server as the first information.

9. A method as claimed in claim 2, wherein the enquiry returns the header of the second information.

10. A method as claimed in claim 9, wherein the enquiry is made using the HTTP (hypertext transfer protocol) HEAD method.

11. A method as claimed in claim 1, comprising: starting the checking of the second information from the first displayed link.

12. A method as claimed in claim 1, comprising: checking the second information from the links displayed at each time, if there are more links that the client is able to display at one time.

13. A method as claimed in claim 2, further comprising:
displaying in the client a search page of the server,
entering a search criterion with the client,
conducting a search on the search page on the basis of the search criterion, and
obtaining the first information to be displayed in the client as a result of the conducted search.

14. A method as claimed in claim 1, further comprising:
entering a search criterion with the client,
conducting a search to the first data storage on the basis of the search criterion,
obtaining the first information to be displayed in the client as a result of the conducted search, and
making an enquiry concerning the second information by analysing the first information and by making an enquiry to the second data storage.

15. A method as claimed in claim 14, wherein the first data storage comprises a publication database and the second data storage comprises a reference database.

16. A method as claimed in claim 15, wherein the first information comprises information on publications and the third information comprises information on the relevance of the publication to the search criterion.

17. A method as claimed in claim 1, wherein the third information is displayed visually with the link.

18. A method as claimed in claim 17, wherein the visuality is implemented at least in one of the following ways: colouring the link in an agreed manner, changing the font of the link in an agreed manner, placing an icon agreed in advance beside the link, changing the order of the links, displaying the third information in a window opened in connection with the link.

19. A method as claimed in claim 1, wherein the client does the automatic checking.

20. An information-processing client, being configured to:
access a server,
display first information returned by the server and containing a link to second information,
check automatically a specific property of the second information by making an enquiry concerning the second information, and
display third information on the specific property of the second information.

21. A client as claimed in claim 20, wherein the client comprises a browser, the first information comprises a first information page, the second information comprises a second information page, and the specific property comprises usability.

22. A client as claimed in claim 21, wherein the third information comprises at least one of the following: the downloadability of the second information onto the client, the downloading rate of the second information onto the client, the downloading time of the second information onto the client, the download size of the second information onto the client, the bandwidth of the data transmission path used for downloading the second information onto the client.

23. A client as claimed in claim 21, wherein the client is also configured to load the second information to a cache memory of the client, if the third information indicates that the second information is downloadable.

24. A client as claimed in claim 23, wherein the client is also configured to load only the text content of the second information.

25. A client as claimed in claim 23, wherein the client is also configured not to execute any automatic functions included in the second information in connection with the download to the cache memory.

26. A client as claimed in claim 23, wherein the client is also configured to perform the download to the cache memory if the second information is at most equal in size to a preset limit.

27. A client as claimed in claim 23, wherein the client is also configured to perform the download to the cache memory if the second information resides on the same server as the first information.

28. A client as claimed in claim 21, wherein the client is also configured to retrieve the header of the second information in the enquiry.

29. A client as claimed in claim 28, wherein the client is also configured to make the enquiry by using the HTTP HEAD method.

30. A client as claimed in claim 20, wherein the client is also configured to start the checking of the second information from the first displayed link.

31. A client as claimed in claim 20, wherein the client is also configured to check the second information from the links displayed at each time, if there are more links that the client is able to display at one time.

32. A client as claimed in claim 21, wherein the client is also configured to:
display a search page of the server,
receive a given search criterion,
start a search on the search page on the basis of the search criterion, and
obtain the first information to be displayed as a result of the conducted search.

33. A client as claimed in claim 20, wherein the client is also configured to:
receive the search criterion,
start a search to the first data storage on the basis of the search criterion,
obtain the first information to be displayed as a result of the conducted search, and
make an enquiry concerning the second information by analysing the first information and by making an enquiry to the second data storage.

34. A client as claimed in claim 33, wherein the first data storage comprises a publication database and the second data storage comprises a reference database.

35. A client as claimed in claim 34, wherein the first information comprises information on publications and the third information comprises information on the relevance of the publication to the search criterion.

36. A client as claimed in claim 20, wherein the client is also configured to display the third information visually with the link.

37. A client as claimed in claim 36, wherein the client is configured to implement the visuality in the first information displayed in the client in at least in one of the following ways: colouring the link in an agreed manner, changing the font of the link in an agreed manner, placing an icon agreed in advance beside the link, changing the order of the links, displaying the third information in a window opened in connection with the link.
